(19) United States
(12) Patent Application Publication
(10) Pub. No.: US 2009/0251100 A1
(43) Pub. Date: Oct. 8, 2009

(54) Stackable battery module

(75) Inventors: Stephen Hart Incledon, Glendora, CA (US); John Branom, Newbury Park, CA (US); Norbert Soski, Granada Hills, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Pratt & Whitney Rocketdyne, Inc., Canoga Park, CA (US)

(21) Appl. No.: 12/080,385

(22) Filed: Apr. 2, 2008

(51) Int. Cl. H02J 7/02; H02J 7/00

(52) U.S. Cl. 320/106; 320/134; 320/137

(57) ABSTRACT

A rechargeable battery assembly includes a battery array and a battery controller. The battery array includes a number of batteries, and each battery includes a battery module and an integral module controller. The batteries may be connected in various configurations to form a battery array that is able to provide a power supply of almost any desired voltage. The module controller regulates charging of the battery module and is able to disconnect defective battery modules from the circuit. During a charging cycle, the module controller disconnects fully-charged modules from the charging circuit. During a discharging cycle, if a battery module becomes inoperative, the module controller disconnects the inoperative module, so that the battery array does not become inoperative because of one or more inoperative battery modules.

### BACKGROUND OF THE INVENTION

This invention relates to rechargeable battery cells. More specifically, the invention relates to a rechargeable battery that includes an integral battery charge-discharge unit (BCDU).

A rechargeable battery cell is normally connected to a voltage-regulated direct current (DC) bus. The battery cell frequently alternates between charge and discharge, depending on the status of the system load and the availability of energy for charging. To control the bus voltage and to regulate the battery charge, a BCDU must be placed between the DC bus and the battery. The BCDU must transfer battery power to the bus on demand, and it also must control the charging current and battery cell voltage. BCDU design differs depending on the bus voltage, the system capacity and the type of battery cell used, and the design is thus unique to each system. The design, manufacturer and qualification of each BCDU design are costly and may require several years.

In addition, battery power supplies include numerous individual battery cells connected together into a battery system. Failure of any individual battery cell in the battery system renders the entire battery/BCDU system inoperative.

Therefore, there is a need for a BCDU that is independent of the system design and the voltage requirements of the system. In addition, there is a need for a BCDU design that provides an uninterrupted power supply, regardless of the failure of one or more individual battery cells in the battery module.

### BRIEF SUMMARY OF THE INVENTION

The invention relates to a battery charge-discharge unit that is integrated into the battery. The invention is modular, such that multiple batteries may be connected in various series and parallel configurations for voltage compatibility in any electrical power system. In addition, the integral battery charge-discharge unit is able to bypass any individual battery module that fails. Thus, the power supply remains operative even if one or more individual battery module fails or otherwise becomes inoperative.

### BRIEF DESCRIPTION OF THE DRAWINGS

FIG. 1 is a block diagram of a battery assembly.

FIG. 2 is a battery charge profile a typical battery module of a battery according to the invention.

FIG. 3 is a block diagram of a battery controller according to the invention.

FIG. 4 is a block diagram of a module controller according to the invention.

FIG. 5 is a circuit diagram of a module controller according to the invention.

### DETAILED DESCRIPTION

The integral BCDU of the invention allows a battery assembly to be used as a power supply for any system and allows multiple batteries to be used in combination with one another to achieve a power supply with almost any desired voltage. It also allows individual battery modules to be bypassed if the individual module fails. As a result, failure of one or more individual battery modules does not result in failure of the entire battery assembly.

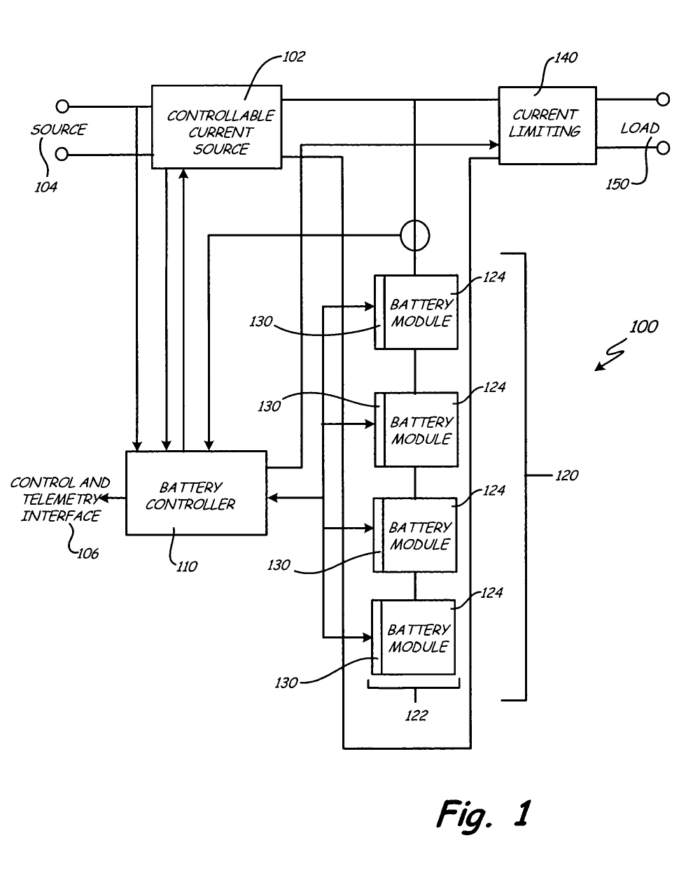

FIG. 1 shows a block diagram of a battery assembly 100, along with other components typically used in conjunction with the battery assembly. Battery assembly 100 includes battery controller 110 and battery array 120. Controllable current source 102, source 104, control and telemetry interface 106, current limiting device 140 and load 150 are components that are used in conjunction with battery assembly 100.

Battery array 120 includes one or more batteries 122. Although FIG. 1 shows four batteries 122, this number of batteries is purely illustrative; there may be any number of batteries 122 in battery array 120, depending upon the desired voltage and other design parameters.

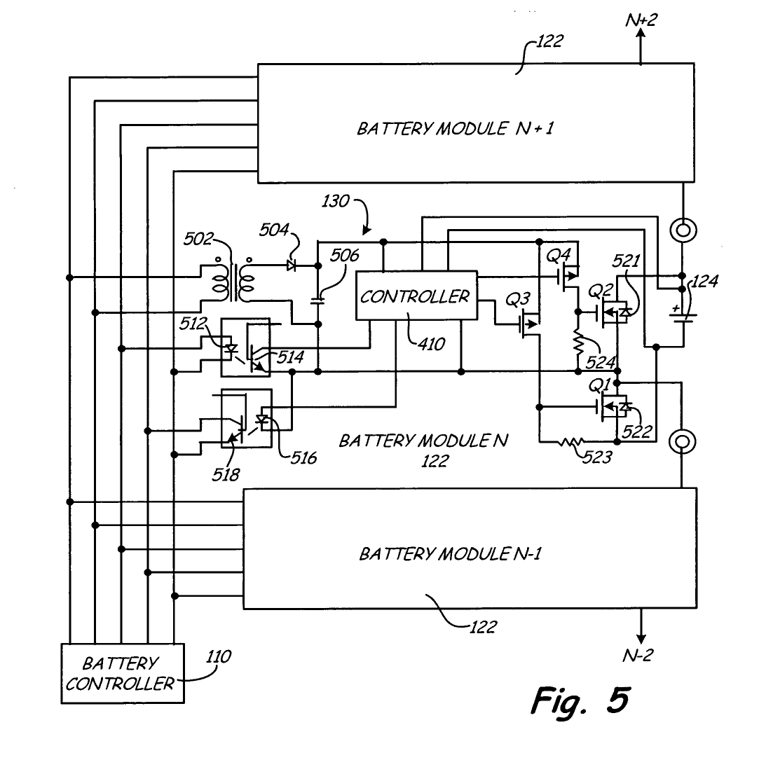

Battery 122 includes individual battery module 124; a bi-directional converter (not shown and discussed in more detail with respect to FIG. 5) that adjusts the terminal voltage to provide charging and discharging at the required cell voltage based on the cell type, state of charge and current; and module controller 130, which is integral with each of batteries modules 124. Battery module 124 is of any battery type known in the art, such as lithium-ion, nickel-metal hydride, nickel-cadmium, nickel hydride, zinc-air, or lead-acid batteries.

Module controller 130 is capable of setting the required terminal voltage of battery module 124 and communicating with battery controller 110 to obtain set-point data and report the status of battery module 124. Module controller 130 controls the final charging of the battery module 124 with which it is integrated. Module controller 130 is also able to bypass individual battery module 124 if individual battery module 124 fails or otherwise become inoperative.

Battery controller 110 is able to determine the status of battery module 124 in battery array 120, identify failures in battery array 120 and modify settings and commands as necessary to control battery array 120. In addition, battery controller 110 sets the operating points of module controllers 130 to obtain the desired characteristics of the battery assembly. It also monitors overall voltage and temperature of the batteries 122 and can be configured to report data or accept instructions from an external system controller, if provided. If the system includes a controllable current source 102 (such as multiple string solar arrays), module controller 130 includes the ability to send and receive data and instructions via control and telemetry interface 106 from a control system (not shown) of the vehicle or other device to which battery assembly 100 is supplying power. It can also provide a signal to a remote power controller to interrupt the output if the battery cells are being discharged beyond an acceptable level.

Battery assembly 100 is connected to controllable current source 102, which is connected to source 104. Controllable current source 102 is a regulated charge source for battery module 100. Controllable current source 102 interacts with battery controller 110, which monitors and controls the operation of battery assembly 100. Although FIG. 1 shows an example of the invention with controllable current source 102, those skilled in the art will recognize that the invention could also be implemented with a controllable voltage source in place of controllable current source 102.

Current limiter 140 is interposed between battery array 120 and load 150. Current limiter 140 protects load 150 by limiting the maximum output from battery assembly 100 so that the batteries are not damaged during discharge of the battery assembly.

Charging of battery assembly 100 includes two parts. The first part, rapid charging of battery assembly 100, is regulated at the battery level. Battery controller 110 controls the rapid charging of all the batteries contained in battery array 120 during the first part of the charging cycle. The second part of the battery charging cycle, final charging of the individual battery modules, is regulated at the individual battery module level. Module controller 130 controls the final charging of each individual battery module 124. Source 104 and controllable current source 102 supply the current that is used for charging during both parts of the charging cycle.

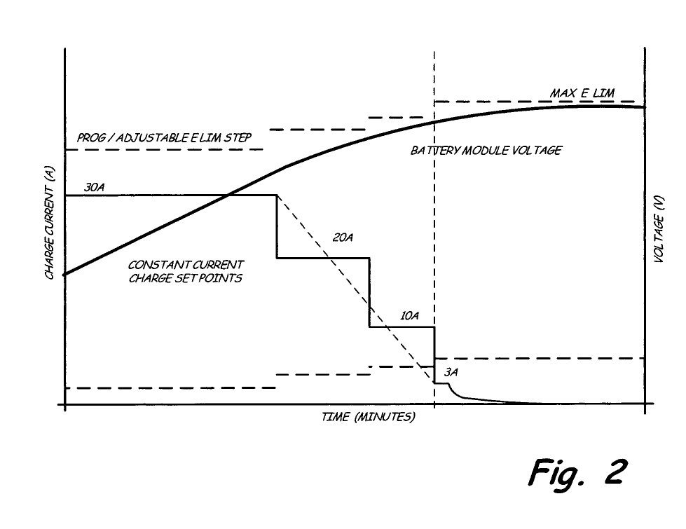

FIG. 2 shows a typical battery charge profile for a lithium-ion battery assembly according to the invention. During the first part of the charging cycle, the output of source 102 to battery array 120 is stepped down by battery controller 110 as individual battery modules 124 reach their voltage level set points or battery array 120 reaches its total voltage limit set point. Battery charging control then moves onto the second stage of battery charging, which takes place at the battery module level.

When each individual battery module 124 of battery array 120 reaches its programmed voltage set point (also known as the “state of charge”), module controller 130 bypasses the charging current around the fully-charged individual battery module 124, thus stopping the charging process for that individual battery module 124 at the programmed voltage level set point. Battery controller 110 continually monitors the cell voltage of each individual battery module 124 of battery array 120. When all of the battery modules 124 of battery array 120 reach their programmed voltage level set point, battery controller 110 terminates cell charging. For a lithium-ion battery, for example, the voltage level set-point for each battery module is programmable by battery controller 110 from 3.5 to 4.2 volts. Although this invention is described generally with respect to lithium-ion batteries, reference to lithium-ion batteries is purely illustrative. The invention may be configured to apply to any battery chemistry, such as nickel-metal hydride, nickel-cadmium, nickel hydride, zinc-air, and lead-acid.

When enabled, battery assembly 100 operates continuously to maintain the bus voltage; supply power to the load, if the source power is insufficient; or absorb power by loading the bus and transferring the power to the battery modules and charging them, if the source power is more than the load requires. During operation, if one or more batteries of battery array 120 fail to operate properly, battery assembly 100 continues to operate by permanently bypassing the inoperative battery. In this situation, battery controller 110 adjusts the set point of the functional batteries to maintain the desired bus voltage, if possible. System operation is therefore maintained after a failure.

During discharge, battery assembly 100 appears to be a two terminal device to the system for which it is supplying power. Also, battery assembly 100 is connected to the system's supply bus, so that the battery terminal voltage is the same as the load voltage.

There are three possible scenarios during discharge of battery assembly 100. In the first scenario, battery assembly 100 is supplying most or all of the load power. Battery modules 124 are being discharged, and battery controller 110 controls the load voltage. In this scenario, battery controller 110, acting through module controller 130, regulates the output voltage and holds it constant. The state of charge of battery assembly 100 cannot be determined by measuring its voltage in this case, but can be obtained by data-linking to battery controller 110.

In the second scenario, the load is supplied by a controlled voltage source (such as a regulated generator) and battery assembly 100 is connected across the supply bus and is being charged from the excess power available from the voltage source. In this scenario, the load bus voltage is controlled by a regulated source and must be higher than the battery regulated voltage, so battery assembly 100 is charged from the voltage source. However, if there were no internal compensation, battery assembly 100 would accept unlimited power from the voltage source and be destroyed. Battery controller 110 thus modifies the internal impedance of battery assembly 100 to charge individual battery modules 124 at an acceptable rate and limit the battery charging to the battery module's fully charged state.

Finally, in the third scenario, if the system includes a controllable current source, the load is supplied by a controlled current source (such as an array of solarvoltaic cells). In this case, battery controller 110 may supply control signals to the current source, maintaining the load at the regulated battery voltage and adjusting the input current to regulate the state of charge.

Battery controller 110 monitors the state of charge of battery assembly 100, commands the voltage set point to each battery module 124, controls the charge current, and communicates externally to report the status of battery assembly 100 and to receive commands from an external user of battery assembly 100. In addition, battery controller 110 provides an isolated power source to supply power to module controller 130 in each individual battery module 124.

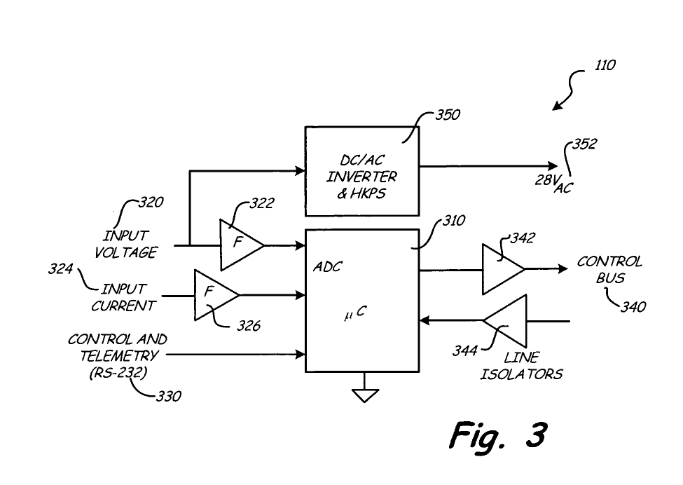

FIG. 3 shows battery controller 110 in more detail. Battery controller 110 includes microcontroller 310, which controls most of the operations of battery controller 110. Microcontroller 310 receives input voltage 320 through buffer 322 and input current through buffer 326. Microcontroller 310 also interacts with control and telemetry system 330 to receive input information and to provide output information regarding battery assembly 100. Microcontroller 310 also interacts with control bus 340 through line isolator buffers 342 and 344. Battery controller 110 also includes DC/AC inverter and housekeeping power supply (HKPS) 350. DC/AC inverter and HKPS 350 receive input voltage 320 and produce output voltage 352, which is used by module controllers 130.

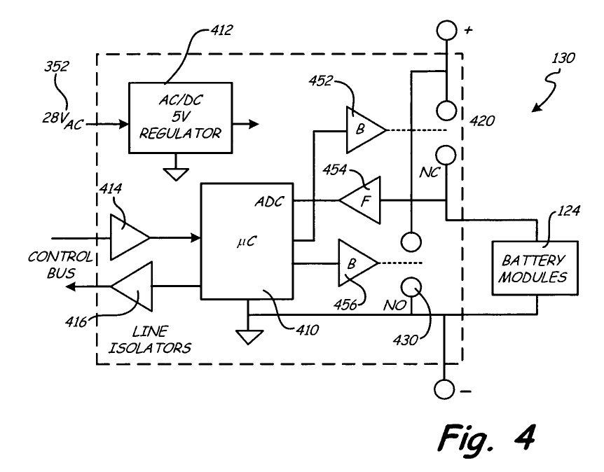

FIG. 4 is a block diagram of module controller 130. Module controller 130 provides voltage control during charging of individual battery modules, and it also provides isolation when the module is discovered to be faulty. Module controller 130 includes microcontroller 410. In one embodiment, microcontroller 410 possesses a 10 bit analog-digital converter and data input and output. Of course, any microcontroller could be used in cell voltage controller 130 and still fall within the scope of this invention. AC/DC converter 412 receives voltage 352 from battery controller 110 as an input, and converts voltage 352 from an AC voltage to an appropriate DC voltage (typically 5 volts) to operate module controller 130. Buffers 414 and 416 act as line isolators between control bus 340 and microcontroller 410.

Switch 420 and switch 430 are capable of connecting battery module 124 with the other battery modules in battery array 120, or bypassing battery module 124, thereby disconnecting it from battery array 120. When switch 420 is closed and switch 430 is open, battery module 124 is connected to battery array 120. When switch 420 is open and switch 430 is closed, battery module 124 is bypassed. Buffers 452, 454 and 456 are interposed between microcontroller 410 and individual battery module 124.

FIG. 5 shows a circuit diagram of module controller 130. As discussed with respect to FIG. 1, battery array 120 includes one or more batteries 122. FIG. 5 shows a circuit diagram for a selected battery N, as well as its location with respect to other batteries. As noted in the discussion of FIG. 1, any number of batteries may be utilized in the invention. In practice, a series of several batteries are connected to a single charging source and a charge controller capable of providing a controlled current. After each individual cell of the several batteries reaches its full charge, the charging current is bypassed around the fully-charged battery to a resistor or other current sink.

Battery controller 110 provides control of module controller 130. Transformer 502, diode 504 and capacitor 506 correspond to AC/DC converter 412 in FIG. 4 and convert an AC power supply input to a DC power supply that operates module controller 130. Diode 512 and transistor 514 correspond to buffer 414, and diode 516 and transistor 518 correspond to buffer 416. They provide line isolation for module controller 130. Module controller 130 also includes microcontroller 410, which controls the operation of module controller 130.

Transistors Q1 and Q2 and diodes 521 and 522 correspond to switches 420 and 430, respectively, in FIG. 4. These transistors operate continuously in conjunction with inductor 540 to adjust the actual module voltage to the desired module voltage. This is a switchmode converter operating at a high frequency (e.g., greater than 50 kilohertz), thus maintaining essentially constant current between the modules and the module terminals. The duty ratio of the two switches is varied to maintain the required voltage ratio. There is no specific transition between battery module charging and discharging: if the bus voltage is driven higher by the source, the excess current is transferred to the battery modules; if the source power is insufficient to support the load at the specified voltage, then current will flow from the battery modules and be transferred to the load.

After all of the battery modules 124 in battery array 120 have become fully charged, the charging cycle is terminated. As mentioned previously, the impedance of the battery system is increased to reduce absorbed power and avoid overcharging. This is accomplished by providing two voltage control modes in the module controller. The normal control mode controls during discharging and normal charging, but if the modules are fully charge, the auxiliary voltage control overrides it and adjust the module voltage upward sufficiently to reduce the charge current as required. Battery array 120 is in this way always ready for use as a power supply.

During operation of battery array 120, one or more of battery modules 124 may prove to be defective. However, battery controller 110 adjusts module controller 130 to allow battery array 120 to continue to function as a power supply even though one or more of the individual battery modules of battery array 120 is no longer operative.

If an individual battery module 124 becomes defective or otherwise inoperative, a bypass relay disconnects the module within the battery and bypasses the module. Thus, the defective individual battery module is bypassed and battery array 120 continues to operate as a power supply. Although the total voltage of battery array 120 is decreased by bypassing the defective battery module, the remaining batteries are adjusted to higher voltage, and are usually sufficient to continue operation of the electrical power system for which battery array 120 is acting as a power supply.

The invention is a module controller that is integral with a rechargeable battery module in a battery, and one or more batteries can be connected to form a battery array. The module controller is operative both during both the charge and discharge phases of the rechargeable battery module. During the charging cycle of an individual battery module, the voltage of the battery module is monitored. When the individual battery module reaches its full charge, the integral module controller bypasses current from the individual module, allowing the charging current to flow to other batteries in the battery array. During discharge of the battery array, if an individual battery module becomes inoperative, its associated integral module controller bypasses the individual module, thereby allowing the battery array to continue to function as a power supply for an electrical power system. The associated battery controller 110 manages the battery assembly to provide the desired bus voltage and to control the state of charge of the individual battery modules to insure they are never over-charged or excessively discharged.

Although the present invention has been described with reference to preferred embodiments, workers skilled in the art will recognize that changes may be made in form and detail without departing from the spirit and scope of the invention.

1. A rechargeable battery comprising:
a rechargeable battery module; and
a module controller integral with the rechargeable battery module.

2. The rechargeable battery of claim 1 wherein the module controller bypasses a battery module that is not operative.

3. The rechargeable battery of claim 1 wherein the module controller regulates charging of the battery module.

4. The rechargeable battery of claim 1 wherein the module controller comprises a microcontroller, AC/DC converter and switches that connect the module controller to the battery module.

5. The rechargeable battery of claim 4 wherein the switches connect the battery module to the module controller during charging of the battery module, and disconnect the battery module from the module controller when charging is completed.

6. The rechargeable battery of claim 4 wherein the switches connect the battery module to the module controller when the battery module is operative, and disconnect the battery module from the module controller when the battery module becomes inoperative.

7. The rechargeable battery of claim 1 wherein the battery module is selected from a group consisting of: lithium-ion, nickel-metal hydride, nickel-cadmium, nickel hydride, zinc-air, and lead-acid.

8. A battery assembly comprising:
a battery array; and
a battery controller:

9. The battery assembly of claim 8 wherein the battery array comprises a plurality of batteries.

10. The battery assembly of claim 9 wherein the battery comprises:
a rechargeable battery module; and
a module controller integral with the rechargeable battery module.

11. The battery assembly of claim 10 wherein the battery controller controls charging of the battery array and the module controller controls charging of the battery module.

12. The battery assembly of claim 10 wherein the module controller bypasses a battery module that is not operative.

13. The battery assembly of claim 10 wherein the module controller comprises a microcontroller, AC/DC converter and switches that connect the module controller to the battery module.

14. The battery assembly of claim 13 wherein the switches connect the battery module to the module controller during charging of the battery module, and disconnect the battery module from the module controller when charging is completed.

15. The rechargeable battery assembly of claim 13 wherein the switches connect the battery module to the module controller when the battery module is operative, and disconnect the battery module from the module controller when battery module becomes inoperative.

16. The battery assembly of claim 10 wherein the battery module is selected from the group consisting of: lithium-ion, nickel-metal hydride, nickel-cadmium, nickel hydride, zinc-air, and lead-acid.

17. A battery assembly comprising:
a battery module;
a module controller integral with the battery module;
a battery controller; and
a power supply.

18. The battery assembly of claim 17 wherein the battery controller controls rapid charging of the battery module.

19. The battery assembly of claim 18 wherein the module controller bypasses the integral battery module when the battery module reaches a voltage set point.

20. The battery assembly of claim 19 wherein the voltage set point is programmable.

21. The battery assembly of claim 17 wherein the module controller bypasses a battery module that is defective.

22. The battery assembly of claim 17 wherein the module controller comprises a microcontroller, AC/DC converter and switches that connect the module controller to the battery module.

23. The battery assembly of claim 22 wherein the switches connect the battery module to the module controller during charging of the battery module, and disconnect the battery module from the module controller when charging is completed.

24. The battery assembly of claim 22 wherein the switches connect the battery module to the module controller when the battery module is operative, and disconnect the battery module from the module controller when battery module becomes inoperative.

25. The battery assembly of claim 17 wherein the battery module is selected from the group consisting of: lithium-ion, nickel-metal hydride, nickel-cadmium, nickel hydride, zinc-air, and lead-acid.
